(19) United States
(12) Patent Application Publication
(10) Pub. No.: US 2014/0032820 A1
(43) Pub. Date: Jan. 30, 2014

(54) DATA STORAGE APPARATUS, MEMORY CONTROL METHOD AND ELECTRONIC DEVICE WITH DATA STORAGE APPARATUS

(71) Applicants: Akinori HARASAWA, Kunitachi-shi (JP); Yoko MASUO, Iruma-shi (JP); Hironobu MIYAMOTO, Yokohama-shi (JP)

(72) Inventors: Akinori HARASAWA, Kunitachi-shi (JP); Yoko MASUO, Iruma-shi (JP); Hironobu MIYAMOTO, Yokohama-shi (JP)

(21) Appl. No.: 13/723,958

(22) Filed: Dec. 21, 2012

Related U.S. Application Data
(60) Provisional application No. 61/675,532, filed on Jul. 25, 2012.

(51) Int. Cl. G06F 12/02

(52) U.S. Cl. CPC G06F 12/0246
USPC 711/103

(57) ABSTRACT

According to one embodiment, a data storage apparatus comprises a first controller, a second controller, and a third controller. The first controller controls first write processing of writing data to a flash memory in accordance with a request from a host. The second controller controls second write processing of writing data to the flash memory, the second write processing is different from the first write processing.

### CROSS-REFERENCE TO RELATED APPLICATIONS

This application claims the benefit of U.S. Provisional Application No. 61/675,532, filed Jul. 25, 2012, the entire contents of which are incorporated herein by reference.

### FIELD

Embodiments described herein relate generally to a data storage apparatus using a nonvolatile memory, a memory control method, and an electronic device with the data storage apparatus.

### BACKGROUND

In recent years, efforts have been made to develop solid-state drives (SSDs) using, as a data storage apparatus, a NAND flash memory (hereinafter sometimes simply referred to as a flash memory) that is a rewritable nonvolatile (or non-transitory) memory. In the SSD, as data in the flash memory is repeatedly rewritten, the rate of storage areas in each block in which valid data (latest data) cannot be stored increases because of the presence of invalid data (data that is not latest). Thus, the SSD executes compaction processing in order to allow storage areas in each block to be effectively utilized. Garbage collection processing is different from the compaction processing in spite of the same purpose to release or clear up memory areas. The compaction processing is processing of releasing memory areas in units of blocks.

The SSD controls the frequencies of data write processing (host-write processing) and compaction processing (particularly compaction write processing) which are carried out in accordance with commands from a host, by setting a processing ratio (HC ratio) for the data write processing and the compaction processing. That is, with the processing ratio set to 1:0, the SSD preferentially carries out the host write processing and does not execute the compaction processing.

The SSD has recently had denser memory cells owing to a miniaturized flash memory and is more likely to be affected by read disturb than ever. This increases the occurrence frequency of a phenomenon in which data located around a read target are corrupted by a read operation performed on the flash memory.

If a correctable error occurs during read, compaction processing is desirably carried out using a block containing the data (logical block) as a preferential compaction target. Here, when the host-write processing on each logical block is completed, the processing ratio is switched. Thus, if the processing ratio is set to 1:0 and the host-write processing is stalled, the compaction processing may be prevented from being carried out for a long time. If the compaction processing fails to be carried out on the preferential compaction target, when read operations concentrate on this block, the corruption of the data around the read target is further accelerated, possibly causing an error correction limit to be exceeded.

### BRIEF DESCRIPTION OF THE DRAWINGS

FIG. 1 is a block diagram illustrating a configuration of an SSD according to an embodiment;

FIG. 2 is a block diagram illustrating a configuration of a main controller according to the embodiment;

FIG. 3 is a block diagram illustrating a configuration of an electronic device with the SSD according to the embodiment;

FIG. 4 is a diagram illustrating compaction processing according to the embodiment;

FIG. 5 is a diagram illustrating the relationship between host-write processing and the compaction processing according to the embodiment; and

FIG. 6 is a flowchart for explaining processing of changing the processing ratio of the host-write processing to the compaction processing.

### DETAILED DESCRIPTION

Various embodiments will be described below with reference to the drawings.

In general, according to one embodiment, a data storage apparatus comprises a first controller, a second controller, and a third controller. The first controller controls first write processing of writing data to a flash memory in accordance with a request from a host. The second controller controls second write processing of writing data to the flash memory; the second write processing is different from the first write processing. The third controller controls a processing ratio of the first write processing to the second write processing, and changes the processing ratio in such a manner that the second write processing is capable of being carried out while the first write processing is suspended if a situation occurs which requires preferential execution of the second write processing before completion of the first write processing.

### [Configuration of a Data Storage Apparatus]

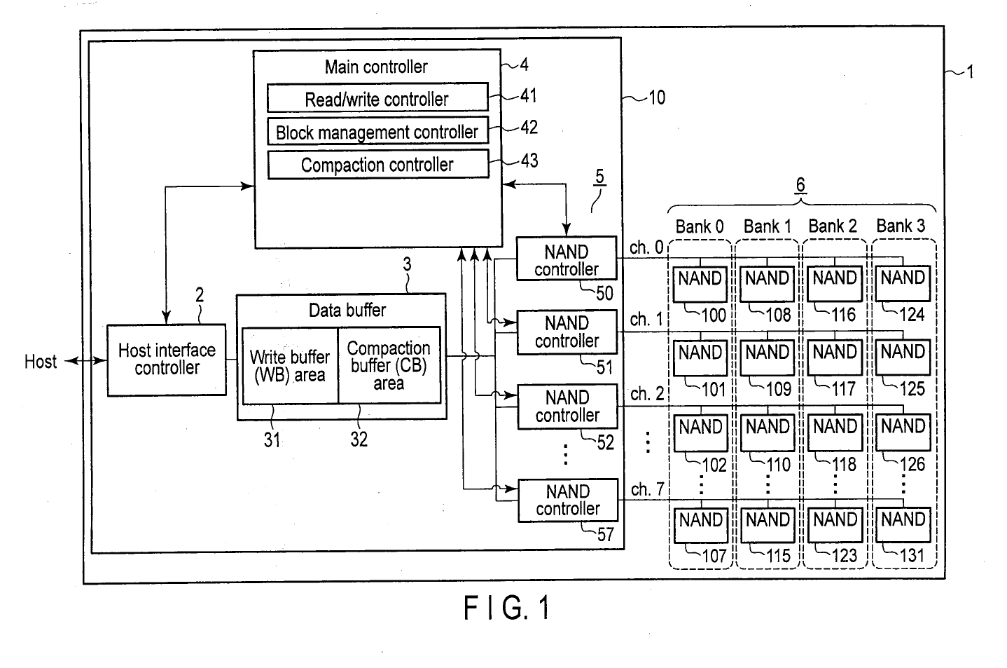

As shown in FIG. 1, a data storage apparatus according to an embodiment is a solid-state drive (SSD) 1 comprising, as a data storage medium, a NAND flash memory (hereinafter referred to as a flash memory) 6 that is a nonvolatile memory. The flash memory 6 comprises a plurality of memory chips 100 to 131 groups in a matrix configuration with channels ch0 to ch7 corresponding to rows and banks 0 to 3 corresponding to columns. Each of the memory chips 100 to 131 comprises a plurality of physical blocks. The physical block is a minimum physical storage area unit that can be independently erased in the flash memory 6. The SSD 1 internally manages a plurality of physical blocks as a logical block. According to the present embodiment, the logical block is sometimes simply referred to as a block.

Now, the definitions of terms used in the present embodiment will be described.

The compaction processing is processing of retrieving a valid cluster from a logical block that is a compaction source block (compaction target block) and migrating the valid cluster to a new logical block (compaction destination block).

A cluster is a data management unit, and for example, one cluster comprises eight sectors. Here, a sector is a minimum unit accessed by the host. Valid clusters hold the latest data. Invalid clusters hold data that is not latest.

A logical block comprises a plurality of physical blocks. According to the present embodiment, one logical block comprises, for example, 8 channels×4 banks×2 planes, that is, 64 physical blocks. The plane is a area that allows for simultaneous accesses within the same memory chip. According to the present embodiment, one plane corresponds to two clusters. The channel is a transmission path through which data are transmitted via a NAND controller. The present embodiment comprises eight channels capable of transmitting up to eight data items in parallel (concurrently). The bank is an aggregation unit of memory chips managed by the NAND controller for each channel.

As shown in FIG. 1, the SSD 1 includes an SSD controller 10 that controls the flash memory 6. The SSD controller 10 comprises a host interface controller 2, a data buffer 3, a main controller 4, and a memory controller 5.

The host interface controller 2 controls transfer of data, commands, and addresses between a host and the SSD 1. Here, the host is a computer or the like which includes an interface conforming to the Serial AT (SATA) standard. The host interface controller 2 stores data transferred by the host (write data) in the data buffer 3. Furthermore, the host interface controller 2 transfers commands and addresses transferred by the host to the main controller 4.

The data buffer 3 is, for example, a buffer memory comprising a dynamic random access memory (DRAM). The data buffer 3 need not necessarily be a DRAM but may adopt any other type of volatile random access memory such as a static random access memory (SRAM). Alternatively, the data buffer 3 may adopt a nonvolatile random access memory such as a magnetoresistive random access memory (MRAM) or a ferroelectric random access memory (FeRAM).

The data buffer 3 comprises a write buffer area (WB area) 31 and a compaction buffer area (CB area) 32. The WB area 31 contains write data transferred by the host (user data). The CB area 32 contains write data for the compaction processing (valid data). The data buffer 3 may include an area in which a logical/physical address conversion table is stored.

The main controller 4 comprises, for example, a microprocessor (MPU) and performs a main control operation on the SSD controller 10. The main controller 4 includes a read/write controller 41, a block management module 42, and a compaction controller 43.

The read/write controller 41 controls read processing and write processing in accordance with a read command and a write command transferred by the host via the host interface controller 2. Furthermore, the read/write controller 41 controls migration processing for compaction processing on the flash memory 6 in accordance with a write command for the compaction processing from the compaction controller 43.

The block management module 42 uses a block management table to manage the status of each block (logical block) and valid clusters in the flash memory 6. The block management table contains management information such as block IDs identifying the respective blocks, the status of each block, and the number of completely written pages. The status of the block is one of Active, Writing, and Free; the Active status indicates that a write to the block has completed, the Writing status indicates that the block is being subjected to a write, and the Free status indicates that no data has been written to the block. That is, in the block management table, free blocks means writable, unused blocks. Furthermore, blocks to which no data can be written because of a fault are referred to as bad blocks.

The compaction controller 43 controls the compaction processing. The compaction processor 43 carries out processing of searching for a compaction source block (compaction target block), processing of searching a block for valid clusters, processing of counting valid clusters, processing of generating a read command or a write command for the compaction processing, and other types of processing. The compaction controller 43 transfers the read command allowing the read processing for the compaction processing and the write command allowing the write processing for the compaction processing, to the read/write controller 41.

The memory controller 5 comprises NAND controllers 50 to 57 for the respective channels ch0 to ch7. The memory controller 5 carries out read or write processing on the flash memory in accordance with commands from the read/write controller 41. Each of the NAND controllers 50 to 57 carries out read or write processing on those of the memory chips 100 to 131 which are located on the corresponding one of the channels ch0 to ch7 in parallel. The memory controller 5 executes read or write processing for the compaction processing on the flash memory 6 in accordance with the command from the read/write controller 41, which cooperates with the compaction controller 43.

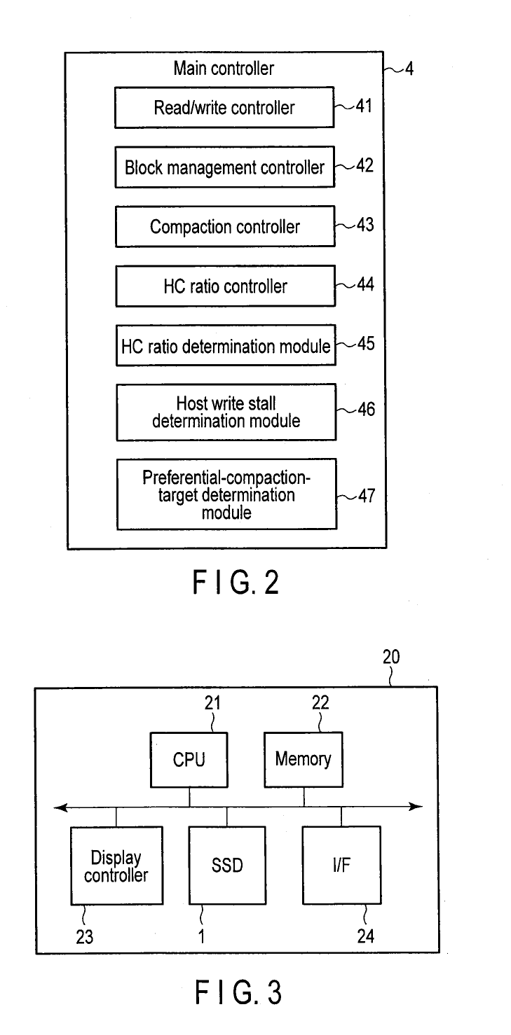

As shown in FIG. 2, the main controller 4 according to the present embodiment includes, in addition to the block management module 42 and the compaction controller 43, a processing ratio (HC ratio) controller 44, a processing ratio (HC ratio) determination module 45, a host write processing stall determination module 46, and a preferential-compaction-target determination module 47. The main controller 4 implements these functions by MPU and software.

The HC ratio controller 44 sets the processing ratio of the host-write processing to the compaction processing (hereinafter sometimes referred to as the HC ratio), for example, in an internal register of the main controller 4. The HC ratio controller 44 controls the processing ratio (frequency) of the host-write processing to the compaction processing based on the set HC ratio (M:N, which is an integer greater than or equal to 0). The unit of M and N is, for example, the number of logical blocks. The HC ratio is also referred to as a gear ratio.

The HC ratio determination module 45 cooperates with the preferential-compaction-target determination module 47 in determining whether or not the set HC ratio is 1:0 when a preferential compaction target is generated. For an HC ratio of 1:0, the HC ratio determination module 45 instructs the HC ratio controller 44 to change the HC ratio. The HC ratio controller 44 normally changes the HC ratio every time write processing in units of logical blocks is completed.

The host-write processing stall determination module 46 determines, during execution of the host-write processing, whether or not the host-write processing is stalled for more than a predetermined time. The host-write processing is controlled by the read/write controller 41 in accordance with a write command from the host. On the other hand, the read/write controller 41 controls the write processing included in the compaction processing carried out on the flash memory 6, in accordance with the write command for the compaction processing from the compaction controller 43.

The preferential-compaction-target determination module 47 determines whether a preferential compaction target has been generated. Specifically, if for example, a correctable error occurs during read processing, the corresponding logical block is determined to be a preferential compaction target. The preferential compaction target is a compaction source block (compaction target block) for use in allowing the compaction processing to be preferentially carried out.

FIG. 3 is a block diagram showing an essential part of an electronic device 20 comprising the SSD 1 according to the present embodiment.

As shown in FIG. 3, the electronic device 20 is, for example, a personal computer comprising a CPU 21, a memory 22, a display controller 23, and an interface (I/F) 24. The electronic device 20 uses the SSD 1 according to the present embodiment as a storage device such as a file retention device. In the electronic device 20, the main controller 4 of the SSD 1 carries out processing such as the control of the processing ratio of the host write processing to the compaction processing based on commands issued by a host controller that is the CPU 21.

### [Compaction Processing]

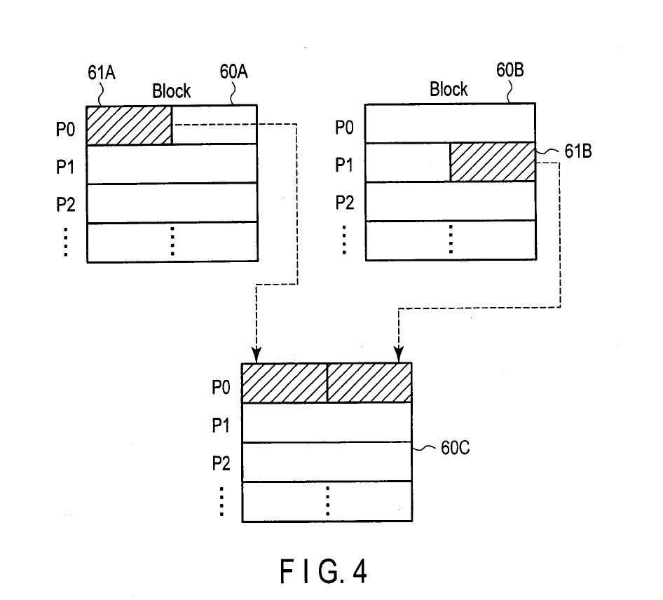

Now, the compaction processing according to the present embodiment will be described in brief with reference to FIG. 4.

In the SSD 1, as data in the flash memory 6 is repeatedly rewritten, the rate of storage areas in each block in which valid data (latest data) cannot be stored increases because of the presence of invalid data (data that are not latest). Thus, the SSD executes compaction processing in order to allow the effective utilization of low-density storage areas with valid data in the block.

As shown in FIG. 4, the compaction controller 43 searches the flash memory 6 for compaction source blocks 60A and 60B (the two logical blocks are discussed for convenience). The compaction source blocks are included in the active blocks with valid data recorded therein and are to be subjected to the compression processing because storage areas with valid date (latest data) have reduced densities. The compaction controller 43 acquires information required to set candidates for the compaction source blocks, from the block management module 42. In this case, for efficient compaction processing, the compaction source blocks to be searched for are desirably low-density blocks with as few valid clusters as possible.

The compaction controller 43 acquires the valid clusters 61A and 61B from the searched compaction source blocks 60A and 60B, respectively. Each block contains log information for use in determining valid clusters and invalid clusters (invalid data).

The compaction controller 43 outputs a read/write command allowing the compaction processing to be carried out to the read/write controller 41. The read/write controller 41 cooperates with the compaction controller 43 in carrying out the compaction processing. That is, the memory controller 5 executes read processing of reading the valid clusters 61A and 61B from the compaction source blocks 60A and 60B, respectively, in accordance with a command from the read/write controller 41. Moreover, the memory controller 5 executes write processing of writing the valid clusters 61A and 61B read from the compaction source blocks 60A and 60B, to a compaction destination block 60C. The compaction destination block 60C is a free block selected from the list in the block management table managed by the block management module 42.

Such compaction processing as described above collects the valid clusters (valid data in units of clusters) 61A and 61B from the compaction source blocks 60A and 60B and migrates the valid clusters 61A and 61B to the compaction destination block 60C. After the migration processing, the compaction source blocks 60A and 60B can be reutilized as free blocks via erase processing.

### [Operation of the Main Controller]

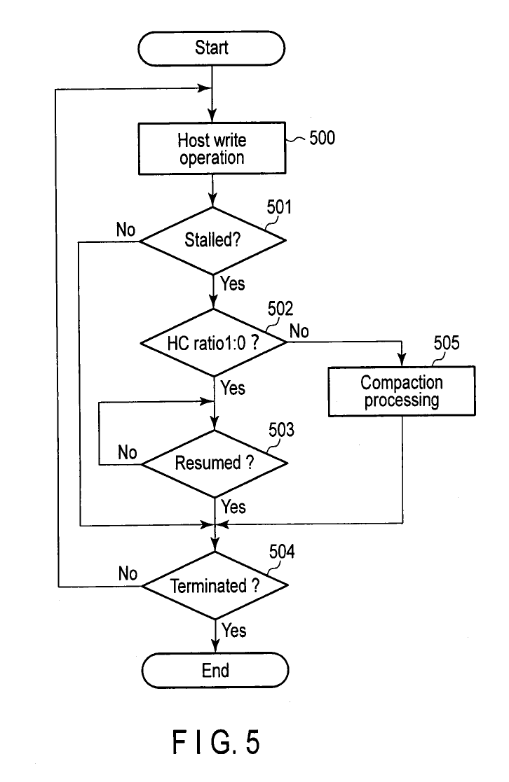

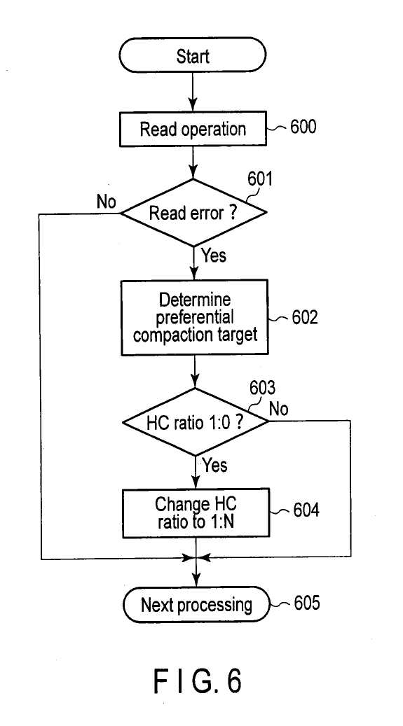

Operation of the main controller 4 will be described below mainly with reference to FIGS. 5 and 6.

As shown in FIG. 5, in the SSD controller 10, when the host interface controller 2 receives a write command and data from the host, the main controller 4 carries out the host write processing (block 500). Specifically, the host interface controller 2 stores the data transferred by the host (write data) in the WB area 31 of the data buffer 3. The read/write controller 41 issues commands to the plurality of NAND controllers 50 to 57 for the respective channels ch0 to ch7. Thus, the data stored in the WB area 31 are written to the memory chips 100 to 131 in the flash memory 6.

According to the present embodiment, the host-write processing stall determination module 46 determines whether or not the host-write processing is stalled for more than a predetermined time (block 501). Upon detecting a stall, the stall determination module 46 notifies the HC ratio determination module 45 of the stall (YES in block 501). The HC ratio determination module 45 determines whether or not the HC ratio is 1:0 (block 502).

Here, for an HC ratio of 1:0, the HC ratio controller 44 controls the processing ratio (frequency) of the host-write processing to the compaction processing such that only the host-write processing is carried out, with the compaction processing not executed. Furthermore, for an HC ratio of 0:1, only the compaction processing is carried out, with the host-write processing not executed. The HC ratio is normally set to M:N (both M and N are integers greater than or equal to 1). Thus, the HC ratio controller 44 controls the processing ratio (frequency) of the host-write processing to the compaction processing using, for example, a processing ratio of 1:2. Then, if the host-write processing is stalled because of the lack of a sufficient logical block, the HC ratio controller 44 instructs the compaction controller 43 to carry out the compaction processing (block 505).

That is, the compaction controller 43 cooperates with the read/write controller 41 in reading data in a valid cluster in a compaction source block, from the flash memory 6. The read/write controller 41 stores the data read from the flash memory 6 in the CB area 32 of the data buffer 3 via the NAND controllers 50 to 57. Once all the data required for the compaction processing are provided in the CB area 32, the read/write controller 41 writes the data to the flash memory 6 via the NAND controllers 50 to 57.

If the HC ratio is 1:0 and the host-write processing is stalled, the compaction processing is not carried out. Thus, the apparatus waits until the host-write processing is resumed (block 503). The HC ratio controller 44 changes the HC ratio every time write processing in units of logical blocks is completed (YES in block 504).

The selected compaction source blocks are normally those of a group of logical blocks which have reduced numbers of valid clusters. Otherwise, if a correctable error occurs during read, the compaction processing is desirably carried out using a logical block containing the corresponding data as a preferential compaction target. This is because the data around the one with the correctable error occurring therein are fatigued to some degree.

Thus, according to the present embodiment, as shown in FIG. 6, the preferential-compaction-target determination module 47 determines whether a preferential compaction target has been generated (block 602). That is, if a correctable error occurs during read processing, the preferential-compaction-target determination module 47 determines the corresponding logical block to be a preferential compaction target (block 600, YES in block 601, and block 602). In the read processing, the read/write controller 41 reads data from the flash memory 6 via the NAND controllers 50 to 57.

The preferential-compaction-target determination module 47 registers a detected preferential compaction target logical block in a table managed by the compaction controller 43, as compaction source block (compaction target block). The HC ratio determination module 45 cooperates with the preferential-compaction-target determination module 47 in determining whether or not the set HC ratio is 1:0 when a preferential compaction target is generated (block 603).

For an HC ratio of 1:0, the HC ratio determination module 45 instructs the HC ratio controller 44 to change the HC ratio (YES in block 603). The HC ratio controller 44 changes the HC ratio to 1:N (N is greater than or equal to 1) (block 604). Thus, if the host-write processing is stalled because of the lack of a sufficient logical block, the HC ratio controller 44 instructs the compaction controller 43 to carry out the compaction processing (see block 505 in FIG. 5). Therefore, the compaction controller 43 can carry out the compaction processing using the registered preferential compaction target logical block as a compaction source block (block 605).

With the HC ratio set to 1:N, when the host-write processing is stalled, the compaction controller 43 carries out the compaction processing (NO in block 603). Thus, the compaction controller 43 can carry out the compaction processing using the registered preferential compaction target logical block as a compaction source block.

Here, the compaction processing according to the present embodiment includes refresh processing of migrating data in a cluster in which a correctable error has occurred during read processing, to another logical block.

As described above, according to the present embodiment, if the processing ratio (HC ratio) is set to 1:0 and the host-write processing is preferentially carried out, the compaction processing can be executed even if the host-write processing is stalled. Thus, particularly if an error during read results in generation of a preferential compaction target while the host-write processing is stalled, the compaction process can be carried out using the preferential compaction processing target logical block as a compaction source block. This allows the appropriate processing ratio of the host-write processing to the compaction processing to be maintained. Hence, a situation can be avoided where the compaction processing fails to be carried out for a long time, leading to generation of a logical block exceeding an error correction limit. As a result, the reliability of the SSD 1 can be maintained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data storage apparatus comprising:
a first controller configured to control first write processing of writing data to a flash memory in accordance with a request from a host;
a second controller configured to control second write processing of writing data to the flash memory, the second write processing being different from the first write processing; and
a third controller configured to control processing ratio of the first write processing to the second write processing and to change the processing ratio in such a manner that the second write processing is capable of being carried out while the first write processing is suspended if a situation occurs which requires preferential execution of the second write processing before completion of the first write processing.

2. The data storage apparatus of claim 1, wherein the third controller is configured to determine whether or not the processing ratio indicates that the first write processing is to be given top priority if the situation requiring the preferential execution of the second write processing occurs and
to change the processing ratio if a result of the determination is affirmative.

3. The data storage apparatus of claim 1, wherein the third controller is configured to determine whether or not the processing ratio indicates that the first write processing is to be given top priority if the first write processing is stalled before being completed and
to change the processing ratio in accordance with the affirmative determination by the determination module in such a manner that the second write processing is capable of being carried out while the first write processing is suspended if a situation occurs which requires preferential execution of the second write processing.

4. The data storage apparatus of claim 1, wherein the second controller is configured to carry out the second write processing included in compaction processing, and
the third controller is configured to change the processing ratio if generation of a preferential compaction target of the compaction processing occurs as the situation.

5. The data storage apparatus of claim 4, wherein the third controller is configured to change the processing ratio every time the first write processing is completed in a predetermined data unit and
to change the processing ratio in such a manner that the second write processing is capable of being carried out while the first write processing is suspended if the preferential compaction target is generated.

6. An electronic device comprising a data storage apparatus comprising a flash memory, the electronic device comprising a host controller configure to control the data storage apparatus, the electronic apparatus comprising:
a first controller configured to control first write processing of writing data to a flash memory in accordance with a request from a host;
a second controller configured to control second write processing of writing data to the flash memory, the second write processing being different from the first write processing; and
a third controller configured to control a processing ratio of the first write processing to the second write processing and to change the processing ratio in such a manner that the second write processing is capable of being carried out while the first write processing is suspended if a situation occurs which requires preferential execution of the second write processing before completion of the first write processing.

7. A memory control method for use in a data storage apparatus comprising a flash memory, the method controlling first write processing of writing data to a flash memory in accordance with a request from a host and second write processing of writing data to the flash memory, the second write processing being different from the first write processing, the method comprising:
controlling a processing ratio of the first write processing to the second write processing; and
changing the processing ratio in such a manner that the second write processing is capable of being carried out while the first write processing is suspended if a situation occurs which requires preferential execution of the second write processing before completion of the first write processing.
